(19) United States
(12) Patent Application Publication
(10) Pub. No.: US 2004/0238979 A1
(43) Pub. Date: Dec. 2, 2004

(54) Method of manufacturing optical cable

(75) Inventors: Masayoshi Yamano, Kanagawa (JP); Takashi Tanaka, Kanagawa (JP); Shigehisa Ishigami, Kanagawa (JP)

Correspondence Address: McDERMOTT, WILL & EMERY, 600 13th Street, N.W., Washington, DC, 20005-3096, US

(73) Assignee: SUMITOMO ELECTRIC INDUSTRIES, LTD.

(21) Appl. No.: 10/811,823

(22) Filed: Mar. 30, 2004

(30) Foreign Application Priority Data
Apr. 3, 2003 (JP) 2003-100541

(51) Int. Cl. B29D 11/00

(52) U.S. Cl. 264/1.28; 264/1.29

(57) ABSTRACT

The degradation of characteristics of an optical cable due to generation of voids caused by gasification of a fiber reinforced plastic (FRP) can be prevented in a method of manufacturing an optical cable, in which an optical fiber and a tension member made of a FRP are coated by extruding a thermoplastic resin around them, the temperature of the thermoplastic resin during extrusion being controlled in the range of 160° C. to 190° C.

### BACKGROUND OF THE INVENTION

1. Field of the Invention

The present invention relates to a method of manufacturing an optical cable by extruding a thermoplastic resin around an optical fiber and a tension member composed of a fiber-reinforced plastic (FRP).

2. Description of the Related Art

As the demand for an optical communication system such as “Fiber to the home” (FTTH) has been increasing, so has the demand for optical cable in recent years. An example of an optical cable used for such a system is an optical drop cable used for branching at least one optical fiber from an aerial distribution cable so as to connect to an individual subscriber residence (see, for example, the Sumitomo Electric Industries, Ltd., April, 2002 general catalog, p. 13 relating to optical cable network systems).

In order to protect the optical fiber from external forces, the optical drop cable is structured such that an optical fiber and a tension member that bears tension are integrally covered with a thermoplastic resin coating formed by extrusion. In the past, a steel wire has generally been used as such a tension member of an optical cable. However, since the optical drop cable is laid from an aerial distribution cable to an indoor system, an induced current generated by, for example, lightening may flow into the indoor system. Accordingly, demand for using a tension member made of insulative FRP, instead of the conductive steel wire, has been increasing.

### SUMMARY OF THE INVENTION

It is an object of the present invention to provide a method of manufacturing an optical cable in which generation of voids due to gasification of FRP can be prevented.

In order to achieve the above object, the present invention provides a method of manufacturing an optical cable by integrally extruding a thermoplastic resin around a tension member and an optical fiber, the tension member being composed of an FRP including a matrix resin containing styrene, wherein the temperature of the thermoplastic resin during extrusion is in the range of 160° C. to 190° C.

The optical cable may be cooled after the extrusion with a cooling medium at a temperature in the range of 15° C. to 50° C. The tension member may further include an adhesive layer around the periphery of its FRP body. Furthermore, the FRP may be a glass fiber reinforced plastic or an aramid fiber reinforced plastic.

Advantages of the present invention will become readily apparent from the detailed description, which illustrates the best mode contemplated for carrying out the invention. The invention is capable of other and different embodiments, the details of which are capable of modifications in various obvious respects, all without departing from the invention. Accordingly, the drawings and description are illustrative in nature, not restrictive.

### BRIEF DESCRIPTION OF THE DRAWINGS

The present invention is illustrated by way of example, and not by way of limitation, in the figures of the accompanying drawing in which like reference numerals refer to similar elements.

FIG. 1 is a sectional view showing an example of an optical cable manufactured by a method of manufacturing an optical cable according to the present invention;

FIG. 2 is a sectional view showing a cross head extruding an optical cable in an embodiment of the method of manufacturing an optical cable according to the present invention;

FIG. 3 is a schematic view showing water troughs for cooling an optical cable; and

FIG. 4 is a longitudinal sectional view showing a portion of an optical cable in the case where styrene monomers are gasified.

### DESCRIPTION OF THE PREFERRED EMBODIMENTS

An FRP is produced as follows: Assembled glass fibers or aramid fibers are impregnated with a matrix resin containing styrene, and the impregnated mixture is heated at 130° C. to 150° C. to thermally cure the matrix resin. Most of the styrene is polymerized to form styrene polymer, whereas the styrene partly remains in the FRP as the styrene monomer.

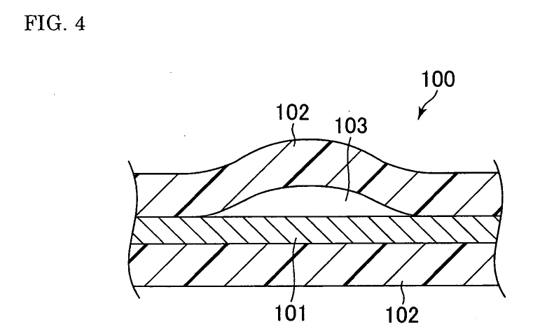

Consequently, when the optical drop cable is manufactured thus using the FRP as the tension member, the styrene monomers remaining in the FRP are gasified due to the accumulated heat in the thermoplastic resin extruded around the FRP. FIG. 4 is a longitudinal sectional view of an optical cable in the case where styrene monomers are gasified. Referring to FIG. 4, a gas generated from the styrene monomer is accumulated as a gas bubble 103 between an FRP 101 and a sheath 102 made of the thermoplastic resin. The surface of the sheath 102 becomes undesirably bumpy due to the gas bubble 103. The bumpy surface impairs the appearance of an optical cable 100.

In some cases, the sheath 102 presses an optical fiber because of the generation of gas bubbles. The pressure deteriorates the transmission characteristics of the optical fiber. If a void generated by the gas bubble is formed on the optical fiber, the infiltration of water in the void significantly decreases the transmission characteristics of the optical fiber. Furthermore, the freezing of the infiltrated water tends to break the optical fiber.

An adhesive layer may be formed between the FRP and the sheath. However, the gasifying of the styrene monomer in the FRP due to the accumulated heat in the sheath readily causes the accumulation of the gas bubbles between the FRP and the adhesive layer. Thus, a similar problem occurs.

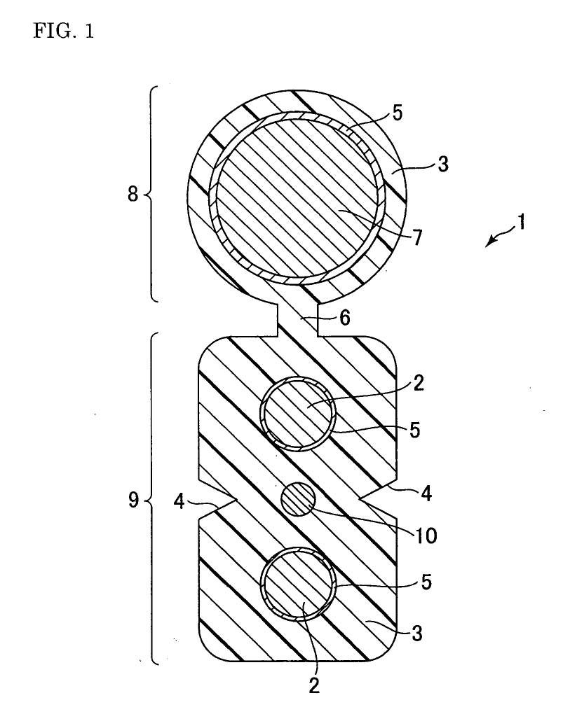

FIG. 1 is a sectional view showing an example of an optical cable manufactured by a method of manufacturing an optical cable according to the present invention. An optical cable 1 is an optical drop cable. The optical cable 1 includes a carrier section 9 and a messenger section 8. A binding portion 6 connects the carrier section 9 and the messenger section 8.

The carrier section 9 includes two tension members 2 and an optical fiber 10 substantially disposed at the center of the tension members 2. The tension members 2 and the optical fiber 10 are coated with a sheath 3 composed of a thermoplastic resin. Examples of the thermoplastic resin preferably include flame-retardant polyethylene and polyvinyl chloride (PVC).

Although the kind and the shape of the optical fiber 10 are not limited, an example of the optical fiber 10 includes a glass body having a core and a cladding, the surface of the glass body being coated with an ultraviolet (UV) curable resin. This optical fiber 10 typically has an outer diameter of 0.25 mm. The optical fiber 10 is, for example, a single-mode optical fiber or a multimode optical fiber. The optical fiber 10 may further include a coloring layer surrounding the UV curable resin. The optical fiber may consist of a plastic body instead of the glass body.

The tension member 2 is composed of an FRP, and has a circular cross-section. The FRP is produced as follows: Assembled glass fibers or aramid fibers are impregnated with a matrix resin containing styrene, and the impregnated mixture is heated at 130° C. to 150° C. to thermally cure the matrix resin. An adhesive layer 5 is formed on the surface of the tension member 2 to securely adhere the tension member 2 to the sheath 3. The adhesive layer 5 preferably is made of polyethylene. As described above, the optical fiber 10 and the tension members 2 are simultaneously coated to form an integral body. Accordingly, the tension members 2 bear external forces such as tensile forces applied to the carrier section 9, thereby protecting the optical fiber 10 from the external forces.

On the outer surface of the carrier section 9, two longitudinal notches 4 are formed in a V-shape toward the optical fiber 10. The notches 4 are formed for the purpose of ease in removing the optical fiber 10 from the carrier section 9: for removing the optical fiber 10, the carrier section 9 can be torn using the notches 4 as a boundary to tear.

The messenger section 8 is strong enough to support the optical cable 1 in aerial application. The messenger section 8 includes a support member 7 composed of, for example, steel or an FRP, and coated with a sheath 3 composed of a thermoplastic resin. An adhesive layer 5 is formed on the surface of the support member 7 so as to secure the adherence between the support member 7 and the sheath 3.

The binding portion 6 unites the carrier section 9 and the messenger section 8 into an integral body. The binding portion 6 combines the carrier section 9 with the messenger section 8. In order to divide the carrier section 9 and the messenger section 8, the binding portion 6 can be readily torn by hand.

According to the present embodiment, the optical cable 1 includes a single optical fiber 10. Instead, two optical fibers may be juxtaposed, or a fiber ribbon having a plurality of optical fibers may be disposed in the optical cable 1. The carrier section 9 may include a single tension member 2 instead of two.

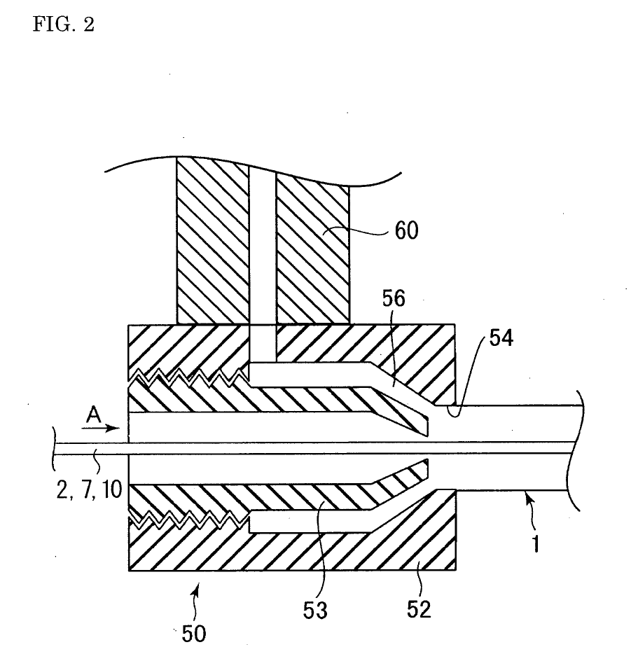

In the following, an explanation will be given about a method of manufacturing the optical cable 1 shown in FIG. 1 by extruding a thermoplastic resin around the tension members 2 and the optical fiber 10. FIG. 2 is a sectional view sowing a crosshead extruding an optical cable in an embodiment of the method of manufacturing an optical cable according to the present invention. Referring to FIG. 2, a crosshead 50 that is a part of an extruder is connected to a cylinder 60. The cylinder 60 supplies a thermoplastic resin melted by heating. An extrusion hole 54 having a cross-section that is substantially the same as the cross-sectional outer shape of the optical cable 1 is formed at the front end (the right edge in the figure) of a die 52 having a cylindrical shape. A nipple 53 is fixed in position at the interior of the die 52, the nipple 53 being disposed having a predetermined clearance from the extrusion hole 54. The clearance between the die 52 and the nipple 53 forms a flow path 56 that is used for extruding the thermoplastic resin.

As shown in FIG. 2, the optical fiber 10, the support member 7, and two tension members 2 having the adhesive layer 5 move from the rear end (the left end in the figure) to the front end of the cross head 50 (i.e., in the direction of the arrow A shown in the figure) in a state such that they are inserted in the nipple 53 and the die 52. The thermoplastic resin supplied from the cylinder 60 through the flow path 56 is extruded into the extrusion hole 54, thereby simultaneously coating the optical fiber 10, the two tension members 2, and the support member 7 so as to form an integral body. Thus, the optical cable 1 is manufactured.

According to the present embodiment of the method of manufacturing an optical cable, the temperature of the thermoplastic resin flowing in the flow path 56 is controlled in the range of 160° C. to 190° C. during extruding with the cross head 50. In this case, the thermoplastic resin can be extruded at a temperature lower than that in a known method, thus decreasing the quantity of heat that is absorbed in the tension members 2 composed of the FRP. Accordingly, this process can suppress the increase of the FRP temperature during the coating of the thermoplastic resin. The gasifying of the styrene monomers in the FRP can be suppressed, thereby preventing the generation of gas bubbles in the areas between the tension members 2 and the adhesive layer 5.

In the case where the FRP is coated with an adhesive layer before the coating of the thermoplastic resin by extrusion, gas bubbles are accumulated between the above FRP and the adhesive layer in a known method. On the other hand, according to the method of the present invention for manufacturing an optical cable, the gasifying of the monomer in the FRP can be suppressed, whereby the generation of bumps on the sheath can be prevented relatively more securely. Furthermore, according to the method of the present invention, even when the FRP does not have an adhesive layer 5 thereon, the generation of the gas bubbles in the areas between the tension members 2 and the sheath 3 can be prevented. Thus, the method of the present invention prevents the degradation of the appearance and the transmission characteristics of the optical cable due to the generation of such gas bubbles.

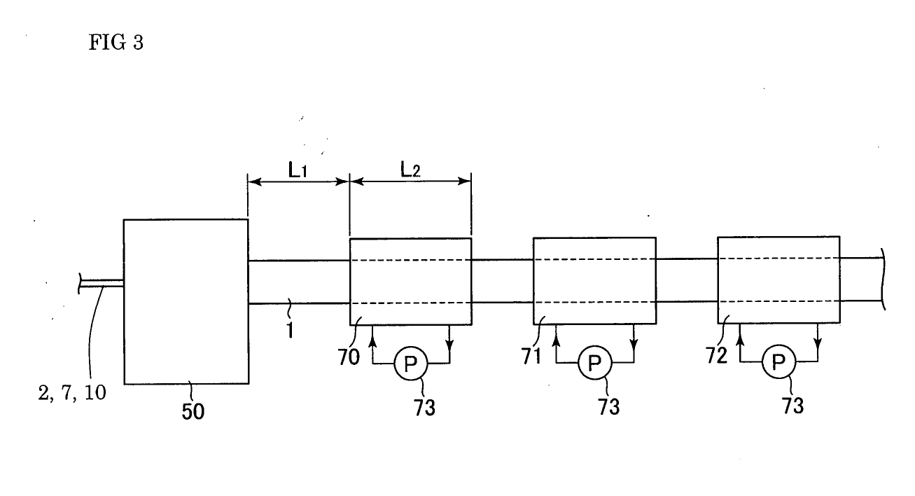

As described above, the optical fiber is coated with the thermoplastic resin by extrusion with the crosshead 50. According to the present invention, immediately after such coating, the sheath 3 made of a thermoplastic resin is cooled with a cooling medium as schematically shown in FIG. 3. The cooling medium may be water. The optical cable 1 thus extruded from the crosshead 50 passes through a first water-cooling trough 70, a second water-cooling trough 71, and a third water-cooling trough 72, which are disposed downstream (the right side in FIG. 3) of the cross head 50, so as to be effectively cooled.

Pumps 73 used for circulating the cooling water are individually connected to the first water-cooling trough 70, the second water-cooling trough 71, and the third water-cooling trough 72. The optical cable 1 is effectively cooled by cooling water in a constantly flowing manner in the water-cooling troughs 70, 71, and 72. The first water-cooling trough 70 is disposed with the distance L1 from the crosshead 50 to be about 20 cm so that the optical cable 1 can be introduced in the first water-cooling trough 70 within about one second after being put out from the crosshead 50. The length L2 of the cooling area in the first water-cooling trough 70 is about 5 to about 10 m. The second water-cooling trough 71 and the third water-cooling trough 72 have the same sizes as in the first water-cooling trough 70, and are disposed in this order adjacent to the water-cooling trough disposed upstream.

The temperature of the cooling water in the first water-cooling trough 70 is controlled in the range of 15° C. to 50° C. According to this temperature range, the deterioration of the appearance of the sheath 3 due to excessively rapid cooling can be avoided, whereas the temperature of the sheath 3 can be decreased as soon as possible. The temperatures of the cooling water in the first water-cooling trough 70, the second water-cooling trough 71, and the third water-cooling trough 72 are controlled such that the temperatures are decreased stepwise in order to cool the optical cable 1 gradually. For example, if the temperature of the cooling water in the first water-cooling trough 70 is controlled at 50° C., the temperatures of the cooling water in the second water-cooling trough 71 and in the third water-cooling trough 72 may be controlled at 30° C. and at 15° C., respectively.

As described above, the temperature of the cooling water in the first water-cooling trough is controlled in the range of 15° C. to 50° C., which is lower than the temperature range in the known method. Consequently, the sheath 3 can be adequately and rapidly cooled, that is, the tension members 2 are not exposed at a high temperature for an extended period of time. Accordingly, the generation of gas bubbles is effectively suppressed.

### EXAMPLES

Optical cables 1 were manufactured with a variety of temperature conditions in which the temperature of the thermoplastic resin used for extruding the coating on an optical cable and the cooling water temperature in the first water-cooling trough were changed. In the optical cables 1, the appearances of the external surface and the frequency of bump generation were evaluated. The frequency of bump generation is defined as the number of bumps per optical cable 1 having a length of 5 km. Regarding the frequency of bump generation, if an optical cable 1 having a length of 5 km includes three bumps or less, the optical cable 1 is defined as a good sample. The experimental results are shown in the table.

TABLE

| | | Cooling | Appearance | | |
|---|---|---|---|---|---|
| | Resin | water | of | Number | |
| Example | temperature | temperature | external | of | Evalu- |
| No. | (° C.) | (° C.) | surface | bump(s) | ation |
| 1 | 155 | 80 | Rough | 0 | C |
| 2 | 160 | 80 | Smooth | 0 | A |
| 3 | 170 | 80 | Smooth | 0 | A |
| 4 | 180 | 80 | Smooth | 0 | A |
| 5 | 180 | 20 | Smooth | 0 | A |
| 6 | 190 | 80 | Smooth | 3 | B |
| 7 | 190 | 60 | Smooth | 1 | B |
| 8 | 190 | 40 | Smooth | 0 | A |
| 9 | 190 | 20 | Smooth | 0 | A |
| 10 | 200 | 80 | Smooth | 12 | C |
| 11 | 200 | 60 | Smooth | 10 | C |
| 12 | 200 | 40 | Smooth | 8 | C |
| 13 | 200 | 20 | Smooth | 5 | C |

A: Superior
B: Satisfactory
C: Inferior

Referring to the table, according to Example 1 in which the temperature of the thermoplastic resin used for the extrusion was 155° C., while the number of bumps was zero, the external surface of the sheath had fine irregularities and was rough like a mat finished surface. This is because the resin temperature was too low. According to Examples 10 to 13 in which the temperature of the thermoplastic resin used for the extrusion was 200° C., while the external surfaces of the sheath were smooth and satisfactory, the number of bumps were 5 or more. This is because the resin temperature was too high.

On the other hand, according to Examples 2 to 5 in which the temperature of the thermoplastic resin used for the extrusion was 160° C. to 180° C., all the external surfaces of the sheaths were smooth: no bump was generated. According to Example 4 and Example 5, in which the cooling water temperatures were 80° C. and 20° C., respectively, both of the evaluation results were superior. According to Examples 6 to 9 in which the temperature of the thermoplastic resin used for the extrusion was 190° C., all the external surfaces of the sheaths were smooth. However, a few bumps were generated in Example 6 in which the cooling water temperature was 80° C. and in Example 7 in which the cooling water temperature was 60° C., whereas no bump was generated in Example 8 in which the cooling water temperature was 40° C. and in Example 9 in which the cooling water temperature was 20° C.

The above experimental results showed that the extrusion with a thermoplastic resin at a temperature in the range of 160° C. to 190° C. provided good optical cables. When the temperature of the thermoplastic resin used for the extrusion was 190° C., the cooling water temperature in the first water-cooling trough was preferably about 15° C. to about 50° C. Under this condition, the number of bumps was suppressed to zero. Furthermore, when the temperature of the thermoplastic resin used for the extrusion was in the range of 160° C. to 180° C., the generation of bumps can be prevented without particular consideration of the cooling water temperature.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

The entire disclosure of Japanese Patent Application No. 2003-100541 filed on Apr. 4, 2003 including specification, claims drawings and summary are incorporated herein by reference in its entirety.

What is claimed is:

1. A method of manufacturing an optical cable comprising:
extruding a thermoplastic resin around at least one tension member and at least one optical fiber, the tension member being a fiber reinforced plastic comprising a matrix resin containing styrene, wherein
the temperature of the thermoplastic resin during extrusion is in the range of 160° C. to 190° C.

2. The method of manufacturing an optical cable according to claim 1, wherein the optical cable is cooled with a cooling medium at a temperature in the range of 15° C. to 50° C. after the extrusion of the thermoplastic resin.

3. The method of manufacturing an optical cable according to claim 1, wherein the tension member further comprises an adhesive layer provided on the surface of the fiber reinforced plastic.

4. The method of manufacturing an optical cable according to claim 1, wherein the fiber-reinforced plastic is a glass-fiber reinforced plastic.

5. The method of manufacturing an optical cable according to claim 1, wherein the fiber-reinforced plastic is an aramid-fiber reinforced plastic.
